(19) United States
(12) Patent Application Publication
(10) Pub. No.: US 2012/0243836 A1
(43) Pub. Date: Sep. 27, 2012

(54) OPTICAL TRANSMISSION APPARATUS USING PLASTIC OPTICAL FIBER

(76) Inventor: Byung Chul KIM, Busan (KR)

(21) Appl. No.: 13/240,643

(22) Filed: Sep. 22, 2011

(30) Foreign Application Priority Data
Mar. 24, 2011 (KR) 10-2011-0026187

(51) Int. Cl. G02B 6/36

(52) U.S. Cl. 385/92; 385/88

(57) ABSTRACT

Disclosed herein is an optical transmission apparatus for transmitting solar light to a lighting apparatus using a plastic optical fiber. A connector is mounted to a light collector. A coupling is inserted into the connector and has a first through hole and a second through hole. The second through hole has a tapered shape. The plastic optical fiber is inserted into the first and second through holes of the coupling. An optical fiber holding jig is inserted into the second through hole and surrounds the plastic optical fiber. A fastening bolt has a hole into which the plastic optical fiber is inserted. The fastening bolt is threaded into the coupling to bring the optical fiber holding jig into close contact with the plastic optical fiber. A fastening nut is threaded over the connector to dispose the coupling in the center hole of the connector.

### BACKGROUND OF THE INVENTION

1. Field of the Invention

The present invention relates generally to an optical transmission apparatus for transmitting solar light, focused on an area of a predetermined size by a lens fastened to a light collector, to a lighting apparatus using a plastic optical fiber and, more particularly, to an optical transmission apparatus which is configured such that the axis of the end of a plastic optical fiber is precisely aligned with the axis of solar light focused by a lens, and a portion of the plastic optical fiber that is disposed adjacent to a light collector is prevented from being damaged by excessive bending, and which can reliably transmit focused solar light to a lighting apparatus through a plastic optical fiber which is comparatively inexpensive.

2. Description of the Related Art

Generally, systems using solar light as light sources for lighting apparatuses include a light collector which collects solar light, a lighting apparatus which uses the collected solar light for lighting, and an optical transmission apparatus which transmits the collected solar light to the lighting apparatus. The structure and shape of the optical transmission apparatus and the lighting apparatus are vastly different depending on whether the light collector collects solar light in such a way as to directly receive it as natural light through a light collection window or whether it is collected in such a way that it is focused on an area very much smaller than the size of the light collection window.

In the case of the latter of these two methods, the light collector includes a lens that tracks the sun, the lens of the light collector focuses solar light on an area of a predetermined size or less, and an optical transmission apparatus including an optical fiber receives the focused solar light and transmits it to a place which needs illumination. Although this method has the disadvantage of a complex structure compared to the former method, active research into this method has recently been made because of the fact that it can track the sun in real time and so can collect solar light regardless of a change in the season or the diurnal motion of the sun.

However, in this method, the lighting apparatus is some distance (typically, 15 m or more) away from the light collector with the lens. Here, in the case of an optical fiber made of glass which is widely used as an optical transmission means in the related art, if the glass optical fiber is directly used over the entire distance which is a long distance, the financial burden becomes excessively huge because it is comparatively expensive. To avoid this problem, techniques of using an optical fiber made of plastic as an optical transmission means in place of the glass optical fiber have been proposed. Representative examples of these techniques are disclosed in Korean Patent Laid-open Publication No. 2001-0079191 and Japanese Patent Laid-open Publication No. 2001-101914.

However, even when the plastic optical fiber is used as an optical transmission means, the following problem remains and must be solved for it to be used, that is, how can the end of the optical fiber be precisely aligned with the optical axis. The reason for this problem is that even if the financial burden can be reduced by using the plastic optical fiber, because the diameter of the optical fiber is limited to a predetermined degree, it is very difficult to align the end of the optical fiber with the optical axis of solar light that is focused by the lens of the light collector on an area of a predetermined size or less. If the end of the optical fiber is not precisely aligned with the optical axis of the solar light, a large portion of the solar light which is obtained by the light collector may be lost. Therefore, a method is required to solve this.

### PRIOR ART DOCUMENT

### Patent Document

(Patent Documents) Korean Patent Laid-open Publication No. 2001-0079191, Japanese Patent Laid-open Publication No. 2001-101914, Korean Patent Laid-open Publication No. 2004-0069075, Korean Patent Registration No. 0673556

### SUMMARY OF THE INVENTION

Accordingly, the present invention has been made keeping in mind the above problems occurring in the prior art, and an object of the present invention is to provide an optical transmission apparatus which can precisely align the axis of the end of a plastic optical fiber with the axis of solar light focused by a lens, thus maintaining the optical axis in the stable state.

Another object of the present invention is to provide an optical transmission apparatus which is configured such that a portion of the plastic optical fiber that is disposed adjacent to a light collector is prevented from being damaged by excessively bending, and a portion of the plastic optical fiber that is behind the rear surface of the light collector is forcibly bent and received in the space behind the rear surface of the light collector, thus making better use of a space, and raising the adaptability of the optical fiber to bending.

A further object of the present invention is to provide an optical transmission apparatus which can reliably transmit focused solar light to a lighting apparatus through a plastic optical fiber which is comparatively inexpensive.

In order to accomplish the above objects, the present invention provides an optical transmission apparatus for transmitting solar light, focused on an area of a predetermined size by a lens fastened to a light collector, to a lighting apparatus using a plastic optical fiber, the optical transmission apparatus including: a connector mounted at a first end thereof to a predetermined portion of a rear surface of the light collector, the connector having a center hole formed in a central portion thereof, with an external thread formed on a circumferential outer surface of a second end of the connector; a coupling inserted into the center hole of the connector, the coupling having a first through hole formed in a first end thereof, and a second through hole formed in a second end thereof, the second through hole communicating with the first through hole and increasing in a diameter from a first end thereof connected to the first through hole to a second end thereof, with an internal thread formed in a circumferential inner surface of the second end of the coupling; the plastic optical fiber inserted into the second through hole and the first through hole of the coupling; an optical fiber holding jig inserted into the second through hole, the optical fiber holding jig surrounding the plastic optical fiber, with a slit formed in the optical fiber holding jig in a longitudinal direction thereof; a fastening bolt having in a central portion thereof a hole into which the plastic optical fiber is inserted, with an external thread formed on a circumferential outer surface of a first end of the fastening bolt so that the fastening bolt is threaded into the coupling by the external thread to bring the optical fiber holding jig into close contact with the plastic optical fiber; and a fastening nut having in a second end thereof a hole into which the second end of the coupling is inserted, with an internal thread formed on a circumferential inner surface of an open first end of the fastening nut so that the fastening nut is threaded over the connector by the internal thread to dispose the coupling in the center hole of the connector.

The optical fiber holding jig may be tapered to correspond to a shape of the second through hole of the coupling.

The optical transmission apparatus may further include a protective tube interposed between the optical fiber holding jig and the plastic optical fiber.

The optical transmission apparatus may further include an elastic member provided around a circumferential outer surface of a portion of the plastic optical fiber adjacent to the fastening bolt to prevent the plastic optical fiber from being damaged by bending.

Furthermore, an end of the elastic member may be inserted into the fastening bolt, and a large-diameter part may be formed on the end of the elastic member. The large-diameter part may be coupled to a stepped portion formed in the fastening bolt.

The optical transmission apparatus may further include a thermal filter provided on a central portion of a front surface of the connector.

### BRIEF DESCRIPTION OF THE DRAWINGS

The above and other objects, features and advantages of the present invention will be more clearly understood from the following detailed description taken in conjunction with the accompanying drawings, in which:

FIG. 1 is an exploded perspective view showing the construction of an optical transmission apparatus, according to an embodiment of the present invention;

FIG. 2 is a sectional view showing the construction of the assembled optical transmission apparatus of FIG. 1; and

FIG. 3 is a sectional view showing a modification of the assembled optical transmission apparatus according to the present invention.

### DESCRIPTION OF THE PREFERRED EMBODIMENTS

Hereinafter, a preferred embodiment of the present invention will be described in detail with reference to the attached drawings. In the description of the embodiment of the present invention, a detailed explanation of contents that are not directly related to the technical characteristics of the present invention or are obvious to those skilled in this art will be omitted.

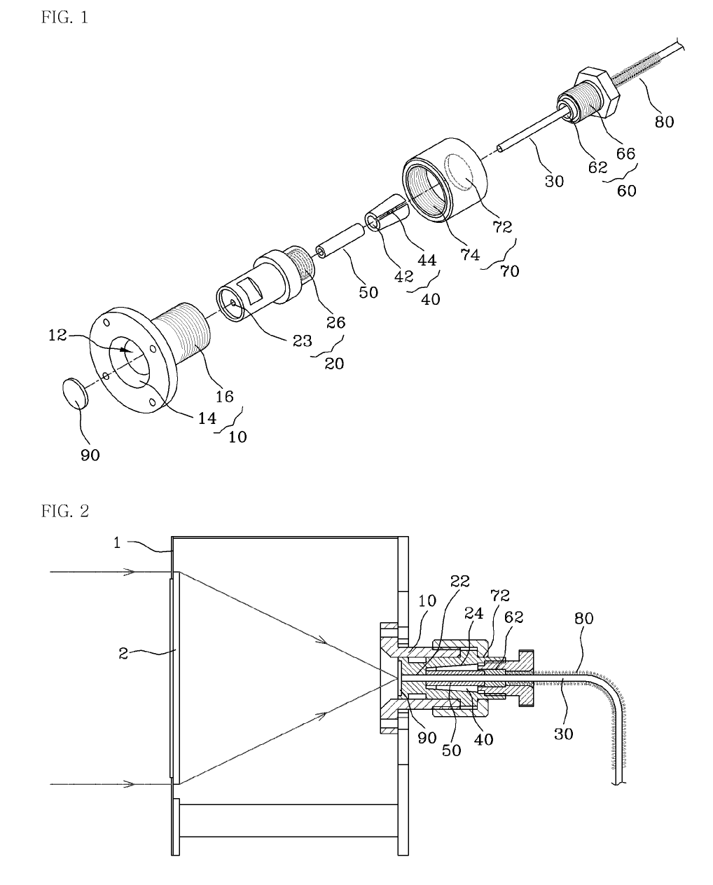

FIG. 1 is an exploded perspective view showing the construction of an optical transmission apparatus, according to the present invention. FIG. 2 is a sectional view showing the construction of the assembled optical transmission apparatus of FIG. 1. As shown in the drawings, the optical transmission apparatus includes a connector 10, a coupling 20, a plastic optical fiber 30, an optical fiber holding jig 40, a fastening bolt 60 and a fastening nut 70.

The connector 10 is a basic body of the optical transmission apparatus according to the present invention and is preferably fastened to a portion of a rear surface of a light collector 1 that directly collects incident solar light. More preferably, the connector 10 is disposed on an optical axis at a position spaced apart from a lens 2 by a predetermined distance such that solar light focused by the lens 2 is directly transmitted to the optical transmission apparatus. A first end of the connector 10 is fastened to the light collector 1 at a position spaced apart from the lens 2 by a predetermined position behind the lens 2. The fastening of the connector 10 to the light collector 1 is realized by a fastening means, such as bolts (not shown) or the like.

Furthermore, a center hole 12 for installation of the coupling 20 to be explained later herein is formed in a central portion of the connector 10. An external thread 16 for coupling of the fastening nut 70 to be explained later herein to the connector 10 is formed around a circumferential outer surface of a second end of the connector 10. A heat dissipation pin (not shown) may be provided at a predetermined position on the circumferential outer surface of the connector 10 to dissipate heat generated by focused solar light. In the drawings, the reference numeral 14 denotes a seating depression into which a thermal filter 90 to be explained later will be seated.

The coupling 20 is inserted into the connector 10 and functions to stably dispose the plastic optical fiber 30 to be explained later in the connector 10. A first through hole 22 and a second through hole 24 which communicate with each other are formed in the coupling 20. Preferably, the second through hole 24 is configured such that the diameter thereof increases from a first end thereof to a second end. An internal thread 26 for coupling of the fastening bolt 60 to be explained later to the coupling 20 is formed on a circumferential inner surface of an end of the coupling 20 that is disposed adjacent to the second through hole 24. To facilitate insertion of the coupling 20 into the center hole 12 of the connector 10, it is preferable that the outer diameter of the coupling 20 be slightly less than the inner diameter of the connector 10. Further, it is preferable for the sake of optical axis alignment that the inner diameter of the first through hole 22 be almost equal to or be slightly less than the outer diameter of the plastic optical fiber 30 that is used.

The plastic optical fiber 30 transmits solar light focused by the lens 2 to a lighting apparatus. The plastic optical fiber 30 is successively inserted into the second through hole 22 and the first through hole 24 of the coupling 20. Preferably, an end of the plastic optical fiber 30 extends to the first end of the center hole 12 of the connector 10. In detail, the end of the plastic optical fiber 30 comes into contact with one surface of the thermal filter 90 that is disposed in the seating depression 14. Any type of plastic optical fiber being sold in the market can be used as the plastic optical fiber 30.

Meanwhile, in the present invention, the end of the plastic optical fiber 30 that extends to the first end of the center hole 12 of the connector 10 may be polished. In this case, the flatness (the surface roughness) of the end of the plastic optical fiber 30 that is in contact with the thermal filter 90 increases. Thereby, the rate of loss of solar light which is caused by a difference in a refractive index on the boundary between the thermal filter 90 and the end of the plastic optical fiber 30 can be markedly reduced. The polishing can be performed by any one of various methods well known to those skilled in this art. Furthermore, in the present invention, the plastic optical fiber 30 may be covered by a protective covering. The protective covering functions to protect the plastic optical fiber 30 from the external environment. It is obvious that the protective covering can be made of at least one selected from the group including well known materials, such as synthetic resin, rubber, fabric, etc.

The optical fiber holding jig 40 is a means for holding the plastic optical fiber 30 to stably dispose it in the coupling 20 and correctly align the optical axis. In detail, the optical fiber holding jig 40 surrounds the plastic optical fiber 30 and is located in the second through hole 24 of the coupling 20. The optical fiber holding jig 40 according to the present invention is characterized by a slit 44 formed in a longitudinal direction. Due to this structure, the plastic optical fiber 30 can be more stably disposed in the coupling 20. Preferably, the optical fiber holding jig 40 has a tapered shape to correspond to the shape of the second through hole 24 of the coupling 20, as shown in the drawings.

Meanwhile, the fastening bolt 60 is coupled to the coupling 20 to bring the optical fiber holding jig 40 into contact with the plastic optical fiber 30. A hole 62 into which the plastic optical fiber 30 is inserted is formed in a central portion of the fastening bolt 60. An external thread 66 corresponding to the internal thread 26 of the coupling 20 is formed on a circumferential outer surface of a first end of the fastening bolt 60. The fastening bolt 60 is advanced towards the connector 10 by tightening the fastening bolt 60 while the threads 26 and 66 engage with each other. Thereby, the optical fiber holding jig 40 can stably hold the plastic optical fiber 30. As such, the optical axis of the plastic optical fiber 30 is primarily aligned by the first through hole 22 of the coupling 20. Also, the plastic optical fiber 30 is further stably supported by the optical fiber holding jig 40 by tightening the fastening bolt 60. Hence, the optical axis can be more reliably aligned.

The fastening nut 70 is a means for fastening the coupling 20 or the assembly of the coupling 20 and the fastening bolt 60 to the connector 10 to dispose the coupling 20 in the connector 10. A hole 72 is formed in a second end of the fastening nut 70. An internal thread 74 is formed on a circumferential inner surface of an open first end of the fastening unit 70. The second end of the coupling 20 is inserted into the hole 72. The internal thread 74 engages with the external thread 16 of the connector 10. Although it is not shown in the drawings, a plurality of depressions may be formed in the circumferential outer surface of the fastening nut 70 to facilitate manual work.

Furthermore, the optical transmission apparatus according to the present invention may further include a protective tube 50 which is interposed between the optical fiber holding jig 40 and the plastic optical fiber 30. When the plastic optical fiber 30 is compressed by the optical fiber holding jig 40 by tightening the fastening bolt 60, the surface of the plastic optical fiber 30 may be damaged. To prevent this, the protective tube 50 may be used as a protective means. Further, the plastic optical fiber 30 can be further stably disposed in the optical fiber holding jig 40 by the protective tube 50, thus making the optical axis alignment of the plastic optical fiber 30 more precise.

Meanwhile, the light collector is located outside a building structure while the lighting apparatus is located in the building structure. Typically, a plurality of plastic optical fibers extend from the rear surface of the light collector 1 in a bundle shape and are bent downwards. In this case, the plastic optical fibers may be excessively bent beyond a predetermined angle, thus deteriorating the optical transmission performance. In severe cases, the plastic optical fibers may be damaged.

In consideration of this point, the present invention further includes an elastic member 80 which is provided on a portion of the plastic optical fiber 30 that is excessively bent beyond a predetermined angle, thus preventing the plastic optical fiber 30 from being damaged. Preferably, to reliably prevent the plastic optical fiber 30 from being damaged by bending, the elastic member 80 covers the circumferential outer surface of the portion of the plastic optical fiber 30 that is disposed adjacent to the fastening bolt 60. More preferably, an end of the elastic member 80 is inserted into the center hole 62 of the fastening bolt 60 to reliably couple the elastic member 80 to the plastic optical fiber 30. The elastic member 80 may comprise a typical spring.

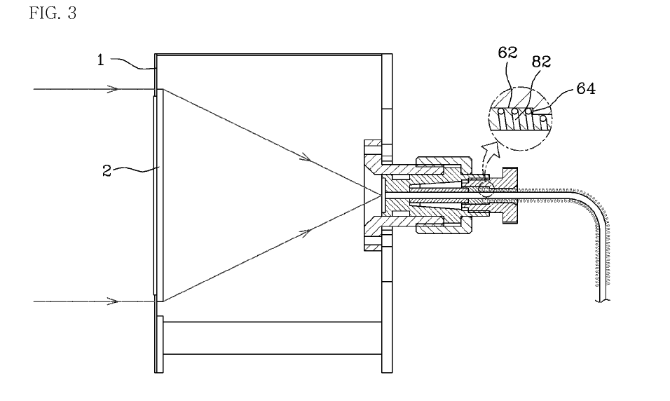

The coupling structure of the elastic member may be configured by the structure of FIG. 3. In this embodiment, the elastic member 80 has a large-diameter part 82 on the end thereof. The large-diameter part 82 is coupled to a stepped portion 64 which is formed in the fastening bolt 60. This structure makes the coupling of the elastic member 80 to the fastening bolt 60 more reliable. Therefore, although the elastic member 80 frequently moves, it can reliably perform the intended function.

Meanwhile, in the present invention, the thermal filter may be provided in the seating depression 14 of the connector 10. The thermal filter 20 functions to prevent the plastic optical fiber 30 from being damaged by high heat which is inevitably generated when solar light is focused on the lens 1. Various methods can be used to fasten the thermal filter 90 to the connector 10, for example, using an adhesive. The thermal filter 90 is preferably made of an IR filter in consideration of the fact that infrared rays of solar light focused on the lens 1 mainly generate heat. Furthermore, the thermal filter 90 may be made of a combination of an IR filter and a UV filter to also remove ultraviolet rays harmful to the human body.

As described above, the present invention provides a method of coupling a plastic optical fiber in a connector using an optical fiber holding jig and a protective tube in a double coupling manner. Therefore, the plastic optical fiber can be very precisely aligned with the axis of solar light focused by a lens.

Furthermore, the plastic optical fiber which protrudes from a rear surface of a light collector is covered by an elastic member. Hence, the plastic optical fiber can be prevented from being damaged when it is bent beyond a predetermined angle. In addition, the plastic optical fiber can be easily received in a comparatively small space behind the rear surface of the light collector. Moreover, the plastic optical fiber can be easily adapted to the state of being bent beyond a predetermined angle.

Further, the present invention includes a thermal filter which is combined with the plastic optical fiber in an appropriate manner so as to prevent the apparatus from being excessively heated by focusing solar light. Therefore, even though the plastic optical fiber that is used cannot withstand heat, focused solar light can be satisfactorily transmitted to a lighting apparatus by the plastic optical fiber.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An optical transmission apparatus for transmitting solar light, focused on an area of a predetermined size by a lens fastened to a light collector, to a lighting apparatus using a plastic optical fiber, the optical transmission apparatus comprising:
a connector mounted at a first end thereof to a predetermined portion of a rear surface of the light collector, the connector having a center hole formed in a central portion thereof, with an external thread formed on a circumferential outer surface of a second end of the connector;
a coupling inserted into the center hole of the connector, the coupling having a first through hole formed in a first end thereof, and a second through hole formed in a second end thereof, the second through hole communicating with the first through hole and increasing in a diameter from a first end thereof connected to the first through hole to a second end thereof, with an internal thread formed in a circumferential inner surface of the second end of the coupling;
the plastic optical fiber inserted into the second through hole and the first through hole of the coupling;
an optical fiber holding jig inserted into the second through hole, the optical fiber holding jig surrounding the plastic optical fiber, with a slit formed in the optical fiber holding jig in a longitudinal direction thereof;
a fastening bolt having in a central portion thereof a hole into which the plastic optical fiber is inserted, with an external thread formed on a circumferential outer surface of a first end of the fastening bolt so that the fastening bolt is threaded into the coupling by the external thread to bring the optical fiber holding jig into close contact with the plastic optical fiber; and
a fastening nut having in a second end thereof a hole into which the second end of the coupling is inserted, with an internal thread formed on a circumferential inner surface of an open first end of the fastening nut so that the fastening nut is threaded over the connector by the internal thread to dispose the coupling in the center hole of the connector.

2. The optical transmission apparatus as set forth in claim 1, wherein the optical fiber holding jig is tapered to correspond to a shape of the second through hole of the coupling.

3. The optical transmission apparatus as set forth in claim 1, further comprising:
a protective tube interposed between the optical fiber holding jig and the plastic optical fiber.

4. The optical transmission apparatus as set forth in claim 1, further comprising:
an elastic member provided around a circumferential outer surface of a portion of the plastic optical fiber adjacent to the fastening bolt to prevent the plastic optical fiber from being damaged by bending.

5. The optical transmission apparatus as set forth in claim 4, wherein an end of the elastic member is inserted into the fastening bolt, and a large-diameter part is formed on the end of the elastic member, the large-diameter part being coupled to a stepped portion formed in the fastening bolt.

6. The optical transmission apparatus as set forth in claim 1, further comprising:
a thermal filter provided on a central portion of a front surface of the connector.
